(19) United States
(12) Patent Application Publication
(10) Pub. No.: US 2025/0036442 A1
(43) Pub. Date: Jan. 30, 2025

(54) EVENT NOTIFICATION AND QUEUEING FOR A CONTAINER ORCHESTRATION SERVICE IN A CLUSTERED NETWORK

(71) Applicant: Dell Products L.P., Round Rock, TX (US)

(72) Inventors: Shefali Gautam, San Mateo, CA (US); George Mathew, Belmont, CA (US)

(21) Appl. No.: 18/359,217

(22) Filed: Jul. 26, 2023

(51) Int. Cl. G06F 9/455

(52) U.S. Cl. CPC G06F 9/45558; G06F 2009/4557

(57) ABSTRACT

A cluster event management module that is deployed in a container orchestration service of a distributed (clustered) network that has multiple running services. The CEM receives and queues events that affect membership changes and system resource (services, nodes, pods) availability, and notifies current subscribed members in so that appropriate action can be taken with respect to their own services and resources. The CEM provides notifications such that events are delivered in the order of generation, all subscribers see the same sequence of events, each event is processed in a hierarchical order across all subscribers in a way that ensures that no event is missed and reliability of event notification is maintained.

### TECHNICAL FIELD

Embodiments are generally directed to distributed networks, and specifically to scaling services running in the network.

### BACKGROUND

Clustered network systems represent a scale-out solution to single node systems by providing networked computers that work together so that they essentially form a single system. Each computer forms a node in the system and runs its own instance of an operating system. The cluster itself has each node set to perform the same task that is controlled and scheduled by software.

A distributed file system is a type of file system in which data may be spread across multiple storage devices as may be provided in a cluster. The distributed file system can present a global namespace to clients in a cluster accessing the data so that files appear to be in the same central location. Distributed file systems are typically very large and may contain many hundreds of thousands or even many millions of files, as well as services (applications) that use and produce data.

There are typically many multiple applications or microservices running in a cluster. When these microservices are running, there will be occasions or ‘events’ that will need to be recognized, transmitted, and acted upon. Such events may include cluster membership changes, services going down, new services getting added, existing services getting deleted, new nodes being added or deleted, and so on. As these events occur, some applications will require tracking such membership changes in the order of occurrence via event notification, and to take some action to reconfigure themselves. What is needed is a system and process for providing notification of cluster events among all of the possible applications in a reliable and efficient manner.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions. Dell and EMC are trademarks of Dell/EMC Corporation.

### BRIEF SUMMARY OF EMBODIMENTS

Embodiments are directed to a cluster event management module (CEM) that is deployed in a container orchestration service of a distributed (clustered) network that has multiple running services. The CEM receives and queues events that affect membership changes and system resource (services, nodes, pods) availability, and notifies current subscribed members in so that appropriate action can be taken. The CEM provides notifications such that events are delivered in the order of generation, all subscribers see the same sequence of events, each event is processed in a hierarchical order across all subscribers.

Embodiments further include a system to generate an ordered reliable event queue on top of a container orchestration service (COS). Membership change events are collected from the COS and delivered to all the subscribers in the order in which it was collected. Any component in the distributed system can produce/generate an event and publish the event to a central event server. The membership event in published events are delivered to all the subscribers in the order it was received. Any component can become a subscriber of a set of events, and publish its desire to become a subscriber to the central event server. When an event is published, the central event server stores the event and delivers the event to a set of subscribers. The act or processes of publishing and delivering an event are decoupled from each other. Upon receipt of an event, each subscriber processes that event by executing a local function (callback) which is pre-determined for that particular event. The list of subscribers at the time of event is embedded in the event data so that receivers know all the subscribers that received the event. If multiple events are published by different components in a time order, then the events are also delivered to all the subscribers in the same exact order of publishing. Priority among multiple subscribers for the same event is maintained in a hierarchical order so that subscribers at higher priority receives the event before subscribers at a lower priority.

### BRIEF DESCRIPTION OF THE DRAWINGS

In the following drawings like reference numerals designate like structural elements. Although the figures depict various examples, the one or more embodiments and implementations described herein are not limited to the examples depicted in the figures.

FIG. 1 is a block diagram of illustrating a distributed system implementing a cluster event notification process, under some embodiments.

FIG. 2 is a block diagram that illustrates the architecture of a Kubernetes platform implementing a service scaling process, under some embodiments.

FIG. 3 is a block diagram that illustrates functional components of a cluster event notification module, under some embodiments.

FIG. 4 is an overall flowchart of cluster event notification operation for the system of FIG. 3, under some embodiments.

FIG. 5 illustrates an event structure and membership list for a CEM module, under some embodiments.

FIG. 6 illustrates prioritization of hierarchical event processing by a CEM module, under some embodiments.

FIG. 7 is a flowchart that illustrates a method of processing events in a CEM, under some embodiments.

FIG. 8 is a table that illustrates Kubernetes events and corresponding CEM action on member states for different service events and node events, under some embodiments.

FIG. 9 illustrates an example of a membership list change based on CEM process, under an example embodiment.

FIG. 10 is a diagram that illustrates posting custom events in a CEM system, under some embodiments.

FIG. 11 is a diagram illustrating a set subscriber workflow, under some embodiments.

FIG. 12 is a block diagram of a computer system used to execute one or more software components of a cluster event notification process, under some embodiments.

### DETAILED DESCRIPTION

A detailed description of one or more embodiments is provided below along with accompanying figures that illustrate the principles of the described embodiments. While aspects of the invention are described in conjunction with such embodiments, it should be understood that it is not limited to any one embodiment. On the contrary, the scope is limited only by the claims and the invention encompasses numerous alternatives, modifications, and equivalents. For the purpose of example, numerous specific details are set forth in the following description in order to provide a thorough understanding of the described embodiments, which may be practiced according to the claims without some or all of these specific details. For the purpose of clarity, technical material that is known in the technical fields related to the embodiments has not been described in detail so that the described embodiments are not unnecessarily obscured.

It should be appreciated that the described embodiments can be implemented in numerous ways, including as a process, an apparatus, a system, a device, a method, or a computer-readable medium such as a computer-readable storage medium containing computer-readable instructions or computer program code, or as a computer program product, comprising a computer-usable medium having a computer-readable program code embodied therein. In the context of this disclosure, a computer-usable medium or computer-readable medium may be any physical medium that can contain or store the program for use by or in connection with the instruction execution system, apparatus or device. For example, the computer-readable storage medium or computer-usable medium may be, but is not limited to, a random-access memory (RAM), read-only memory (ROM), or a persistent store, such as a mass storage device, hard drives, CDROM, DVDROM, tape, erasable programmable read-only memory (EPROM or flash memory), or any magnetic, electromagnetic, optical, or electrical means or system, apparatus or device for storing information. Alternatively, or additionally, the computer-readable storage medium or computer-usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory. Applications, software programs or computer-readable instructions may be referred to as components or modules. Applications may be hardwired or hard coded in hardware or take the form of software executing on a general-purpose computer or be hardwired or hard coded in hardware such that when the software is loaded into and/or executed by the computer, the computer becomes an apparatus for practicing the invention. In this specification, these implementations, or any other form that the invention may take, may be referred to as techniques. In general, the order of the steps of disclosed processes may be altered within the scope of the described embodiments.

Embodiments are directed to a comprehensive event notification process that notifies applications in a clustered file system or network of events that affect membership changes in the cluster.

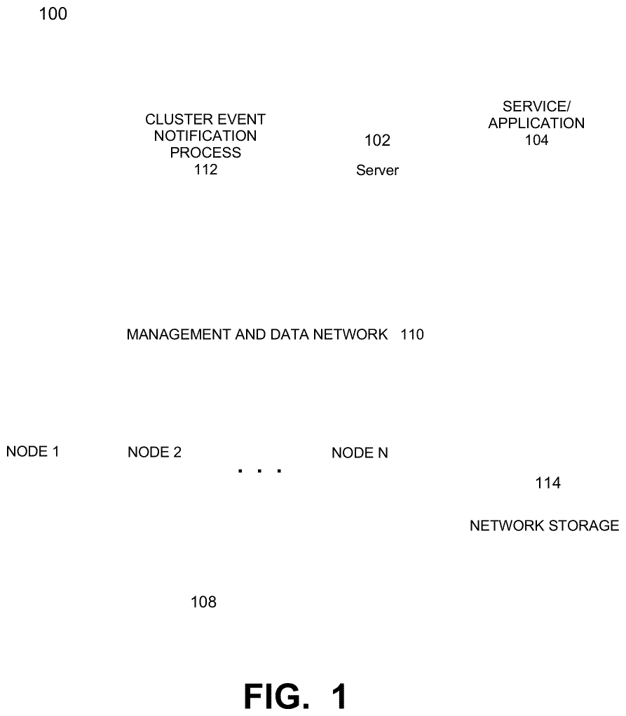

FIG. 1 is a block diagram of illustrating a distributed system implementing a cluster event notification process, under some embodiments. System 100 comprises a large-scale network that includes a number of different devices, such as server or client computers 102, nodes 108, storage devices 114, and other similar devices or computing resources. Other networks may be included in system 100 including local area network (LAN) or cloud networks, and virtual machine (VM) storage or VM clusters. These devices and network resources may be connected to a central network, such as a data and management network 110 that itself may contain a number of different computing resources (e.g., computers, interface devices, and so on). FIG. 1 is intended to be an example of a representative system implementing a distributed computing system under some embodiments, and many other topographies and combinations of network elements are also possible.

A distributed system typically consists of various components (and processes) that run in different computer systems (also called nodes) that are connected to each other. These components communicate with each other over the network via messages and based on the message content, they perform certain acts like reading data from the disk into memory, writing data stored in memory to the disk, perform some computation (CPU), sending another network message to the same or a different set of components and so on. These acts, also called component actions, when executed in time order (by the associated component) in a distributed system would constitute a distributed operation.

A distributed system may comprise any practical number of compute nodes 108. For system 100, n nodes 108 denoted Node 1 to Node N are coupled to each other and server 102 through network 110. Theses client compute nodes may include installed agents or other resources to process the data of application 104. The application at the server 102 communicates with the nodes via the control path of network 110 and coordinates with certain agent processes at each of the nodes 108 to perform application functions of the distributed file system.

The network 110 generally provide connectivity to the various systems, components, and may be implemented using protocols such as Transmission Control Protocol (TCP) and/or Internet Protocol (IP), well known in the relevant arts. In a cloud computing environment, the applications, servers and data are maintained and provided through a centralized cloud computing platform.

For the example network environment 100 of FIG. 1, server 102 is an application server that executes one or more applications or processes 104 that processes data in the system using one or more nodes 108. One typical application is a data backup management application that coordinates or manages the backup of data from one or more data sources, such as other servers/clients to storage devices, such as network storage 114 and/or virtual storage devices, or other data centers. The data generated or sourced by system 100 may be stored in any number of persistent storage locations and devices, such as local client or server storage. The storage devices represent protection storage devices that serve to protect the system data through applications 104, such as a backup process that facilitates the backup of this data to the storage devices of the network, such as network storage 114, which may at least be partially implemented through storage device arrays, such as RAID (redundant array of independent disks) components.

In an embodiment network 100 may be implemented to provide support for various storage architectures such as storage area network (SAN), Network-attached Storage (NAS), or Direct-attached Storage (DAS) that make use of large-scale network accessible storage devices 114, such as large capacity disk (optical or magnetic) arrays for use by a backup server, such as a server that may be running Networker or Avamar data protection software backing up to Data Domain protection storage, such as provided by Dell/EMC™ Corporation.

In an embodiment, system 100 uses Kubernetes as an orchestration framework for clustering the nodes 1 to N in FIG. 1. Application containerization is an operating system level virtualization method for deploying and running distributed applications without launching an entire VM for each application. Instead, multiple isolated systems are run on a single control host and access a single kernel. The application containers hold the components such as files, environment variables and libraries necessary to run the desired software. Because resources are shared in this way, application containers can be created that place less strain on the overall resources available.

Containerization technology involves encapsulating an application in a container with its own operating environment, and the well-established Docker program deploys containers as portable, self-sufficient structures that can run on everything from physical computers to VMs, bare-metal servers, cloud clusters, and so on. The Kubernetes system manages containerized applications in a clustered environment to help manage related, distributed components across varied infrastructures. Certain applications, such as multi-sharded databases running in a Kubernetes cluster, spread data over many volumes that are accessed by multiple cluster nodes in parallel. For application consistency, programs, such as DLM, must be able to guarantee cross-cluster consistency in the context of an application consistent execution.

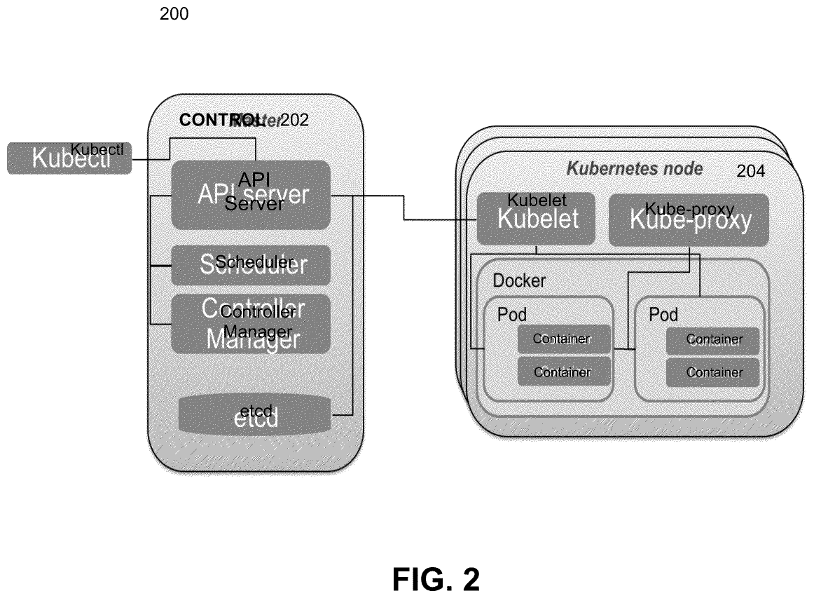

In a Kubernetes system, a cluster consists of at least one cluster master and multiple worker machines called nodes. A cluster is the foundation the system and the Kubernetes objects that represent the containerized applications all run on top of a cluster. FIG. 2 is a block diagram 200 that illustrates the architecture of a Kubernetes platform implementing an service scaling process 112, under some embodiments. The controlling services in a Kubernetes cluster are called the control plane 202 components. These operate as the main management contact points for administrators, and also provide many cluster-wide systems for the relatively dumb worker nodes. These services can be installed on a single machine, or distributed across multiple machines. The servers running these components have a number of unique services that are used to manage the cluster's workload and direct communications across the system.

Within the control plane is an API server that allows a user to configure many of Kubernetes' workloads and organizational units. It also is responsible for making sure that the etcd store (which stores configuration data to be used by the nodes) and the service details of deployed containers are in agreement. It acts as the bridge between various components to maintain cluster health and disseminate information and commands. The API server implements a RESTful interface, which means that many different tools and libraries can readily communicate with it. A client called kubecfg is packaged along with the server-side tools and can be used from a local computer to interact with the Kubernetes cluster.

The controller manager service is a general service that has many responsibilities. It is responsible for a number of controllers that regulate the state of the cluster and perform routine tasks. For instance, the replication controller ensures that the number of replicas defined for a service matches the number currently deployed on the cluster. The details of these operations are written to etcd, where the controller manager watches for changes through the API server. When a change is seen, the controller reads the new information and implements the procedure that fulfills the desired state. This can involve scaling an application up or down, adjusting endpoints, and so on.

The scheduler assigns workloads to specific nodes in the cluster. This is used to read in a service's operating requirements, analyze the current infrastructure environment, and place the work on an acceptable node or nodes. The scheduler is responsible for tracking resource utilization on each host to make sure that workloads are not scheduled in excess of the available resources. The scheduler must know the total resources available on each server, as well as the resources allocated to existing workloads assigned on each server.

In Kubernetes, servers that perform work are known as nodes 204. Node servers have a few requirements that are necessary to communicate with the control plane components 402, configure the networking for containers, and run the actual workloads assigned to them. The first requirement of each individual node server is docker. The docker service is used to run encapsulated application containers in a relatively isolated but lightweight operating environment. Each unit of work is, at its basic level, implemented as a series containers that must be deployed.

The main contact point for each node with the cluster group is through a small service called kubelet. This service is responsible for relaying information to and from the control plane services, as well as interacting with the etcd store to read configuration details or write new values. The kubelet service communicates with the control plane components to receive commands and work. Work is received in the form of a “manifest” which defines the workload and the operating parameters. The kubelet process then assumes responsibility for maintaining the state of the work on the node server. To allow individual host subnetting and make services available to external parties, a small proxy service is run on each node server. The proxy forwards requests to the correct containers, performs load balancing, and other functions.

While containers are used to deploy applications, the workloads that define each type of work are specific to Kubernetes. Different types of ‘work’ can be assigned. Containers themselves are not assigned to hosts. Instead, closely related containers (that should be controlled as a single ‘application’) are grouped together in a pod. This association leads all of the involved containers to be scheduled on the same host. They are managed as a unit and they share an environment so that they can share volumes and IP space, and can be deployed and scaled as a single application.

In an embodiment, the clustered network 100 may implement a Santorini system architecture, though other similar systems are also possible. Each node in such a system consists of several distinct components or processing layers, such as a PowerProtect Data Manager layer, a Data Domain (deduplication backup) appliance microservices layer, a Kubernetes layer 210, a processor layer, and a storage. Each of these component products consists of multiple microservices, and as more nodes are added, the Santorini architecture scales CPU, storage, RAM, and networking accordingly. A Santorini system keeps cluster-wide metadata that maps an Mtree to a domain and nodes to the domain, and the system is always initialized with one domain referred to as the ‘default domain.’ Users can create more domains and add nodes as desired to these domains. Santorini is one example of a distributed file system, and other systems may also be used.

In general, a service can be any application or program that consumes resources provided among a number of nodes in a cluster. It can be embodied as, for example, a thread pool where a certain set of threads allocate resources among nodes in a cluster for a service. Embodiments will be described and illustrated with respect to a Distributed Lock Manager (DLM) service, but embodiments are not so limited and any other similar service may also be used.

In Santorini, there will be multiple applications and microservices running on a cluster that prompt events including membership and microservice changes. As these events occur, applications should be notified in case they need to take action or reconfigure themselves in some way. For example, when a service when it comes up, it would need to know the set of existing services in the cluster. Once this data is probed, a change in membership event is delivered to the service so that an accurate membership list can be maintained. A change in membership event should be delivered to a set of services in a specific order. If a service is partitioned out and is not in the membership, that service will be fenced out so that it cannot access file system data/metadata. If a series of events are generated, they should delivered to the subscribers in the same order in which it was generated so that a replicated state machine can be implemented. Any event should be delivered to the subscribers only once, and no event should be missed. Shortcomings in present systems mean that at least some of these requirements for event notification are not currently met.

As shown in FIG. 1, system 100 includes a cluster event notification module or process (CEM) 112 that is executed by the system to provide notification of events involving membership changes in the cluster. As shown in FIG. 1, process 112 runs as a service in the Santorini cluster, where it processes both Kubernetes and custom events. Kubernetes events include ‘K8s Service’ pods coming up/down, or physical nodes added/deleted/down, and custom events are events generated by applications/subscribers, e.g., a service generating a log-replay event for other services to consume.

The CEM 112 also maintains a queue for enqueuing the events, and processes the queue to deliver events to subscribers in the order of occurrence, where all subscribers view the events in the same order. It also ensures every event is processed on the clients in hierarchical order, i.e., in order of the priority, and supports only a single time processing of the events. The CEM also persists queue to support high availability and reliability.

There may be certain CEM support operations, such as registering with CEM, tracking and delivering Kubernetes service/node events to subscribers, post-custom events (non-Kubernetes events) to be delivered to subscribers, and deregistering with the CEM.

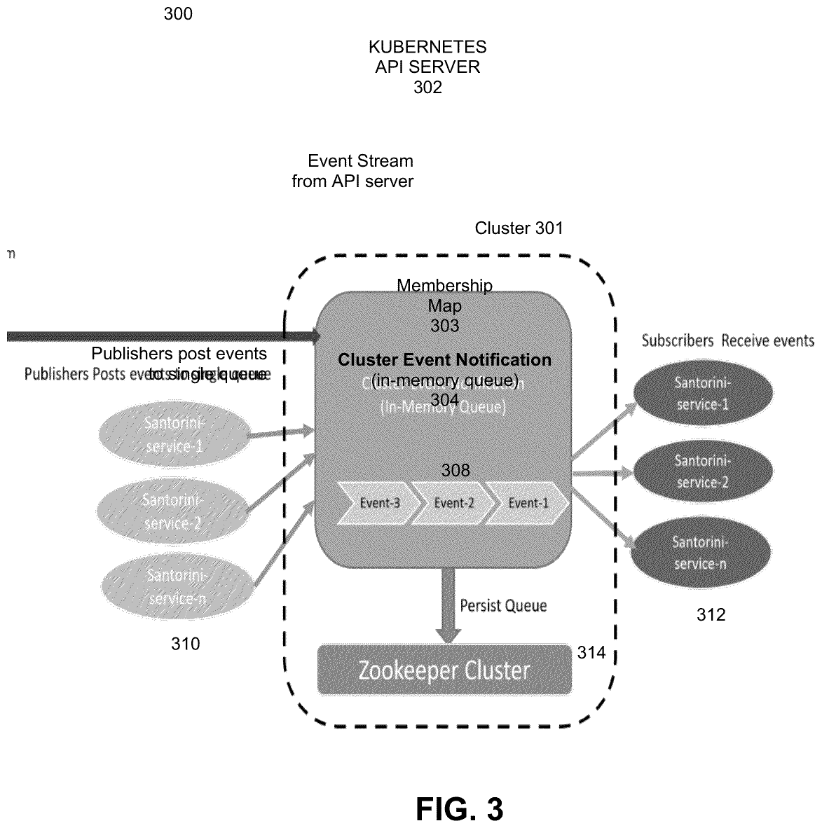

FIG. 3 is a block diagram that illustrates functional components of a cluster event notification module (CEM), under some embodiments. System 300 of FIG. 3 includes a Kubernetes API server 302 that transmits an event stream to a cluster 301. As mentioned above, this event stream comprises Kubernetes events, such as service pods coming up or going down, or physical nodes being added or deleted, or nodes being down, among other similar events.

An event processor in cluster 301 creates a membership map 303. The membership map is generally dynamic in that it changes upon addition, deletion, or status change of members over time, and can be formatted in any appropriate manner, such as a database element.

A cluster event notification module (CEM) 304 runs as a service in the cluster 301. The CEM maintains a single queue 308 for events, such as example events Event-1, Event-2, and Event-3, which are posted by publishers to the queue through one or more services 310. Whereas the API server 302 generally serves Kubernetes events, the publisher services 310 may generate custom events. Subscribers 312 then receive the events from the queue. For system 300, a special cluster called a ‘zookeeper’ cluster 314 is used to store (persist) the queue 308 for high availability (HA) purposes.

The CEM 304 in system 300 enables applications to act on membership changes or other custom events in an ordered way. It acts as temporary storage for event messages coming from either Kubernetes API server 302 or, custom event message coming from the registered publishers or subscribers. At a high level, the CEM performs the main functions of (1) watching the API server for events corresponding to resources such as services, pods, and nodes, (2) queues incoming events, and (3) publishes the queued events to clients (subscribers).

The CEM maintains a single queue where all the incoming event messages are queued. The queue is used is to make sure that events are queued and delivered to clients in the order of occurrence. When events are queued, they are also persisted in zookeeper for high availability and reliability. The events queued are published to clients/subscribers in the background. Therefore, the two operations, queuing and message delivery, are decoupled from each other. This implies, at the time when events are queued, they are not necessarily published as that happens in the background.

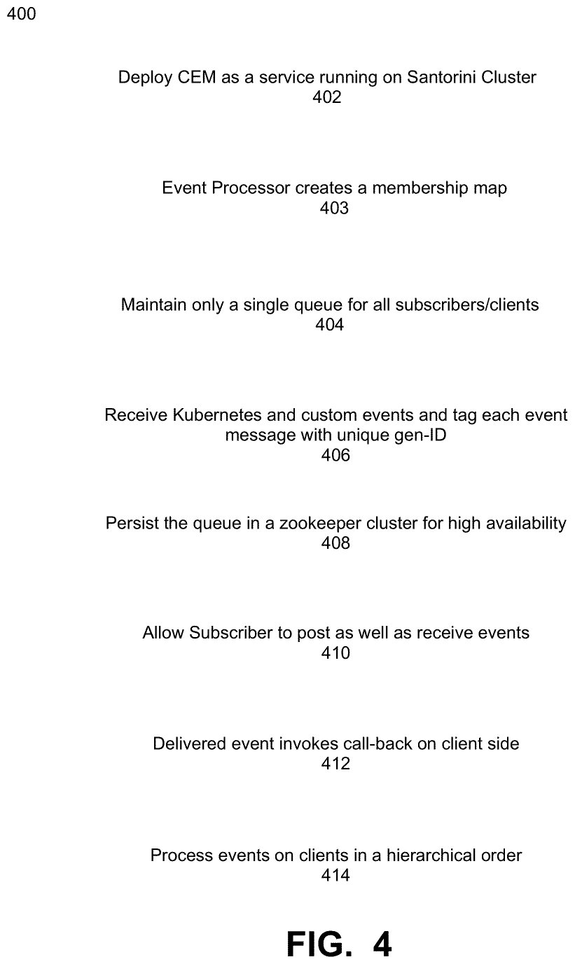

FIG. 4 is an overall flowchart of CEM operation for system 300, under some embodiments. As shown in FIG. 4, process 400 starts with deploying the CEM as a service running in the Santorini Cluster, 402. An event processor creates a membership map, 403.

The CEM maintains only a single queue for all subscribers/clients, 404.

The CEM receives Kubernetes events from a Kubernetes API and custom events from publishers, and tags each event message with a unique gen-ID, 406.

The CEM persists the queue in a zookeeper cluster of the system to maintain high availability of the information, 408.

The system allows a subscriber service to post as well as receive events, 410, and a delivered event will invoke a call-back on the client side 412.

The events processed on clients in a hierarchical order as dictated by the queue, 414.

The process of FIG. 400 implements a system to generate an ordered reliable event queue on top of a container orchestration service (COS). Membership change events are collected from the COS and delivered to all the subscribers in the order in which it was collected. Any component in the distributed system can produce/generate an event and publish the event to a central event server. The membership event in published events are delivered to all the subscribers in the order it was received. Any component can become a subscriber of a set of events, and publish its desire to become a subscriber to the central event server. When an event is published, the central event server stores the event and delivers the event to a set of subscribers. The act or processes of publishing and delivering an event are decoupled from each other. Upon receipt of an event, each subscriber processes that event by executing a local function (callback) which is pre-determined for that particular event. The list of subscribers at the time of event is embedded in the event data so that receivers know all the subscribers that received the event. If multiple events are published by different components in a time order, then the events are also delivered to all the subscribers in the same exact order of publishing. Priority among multiple subscribers for the same event is maintained in a hierarchical order so that subscribers at higher priority receives the event before subscribers at a lower priority.

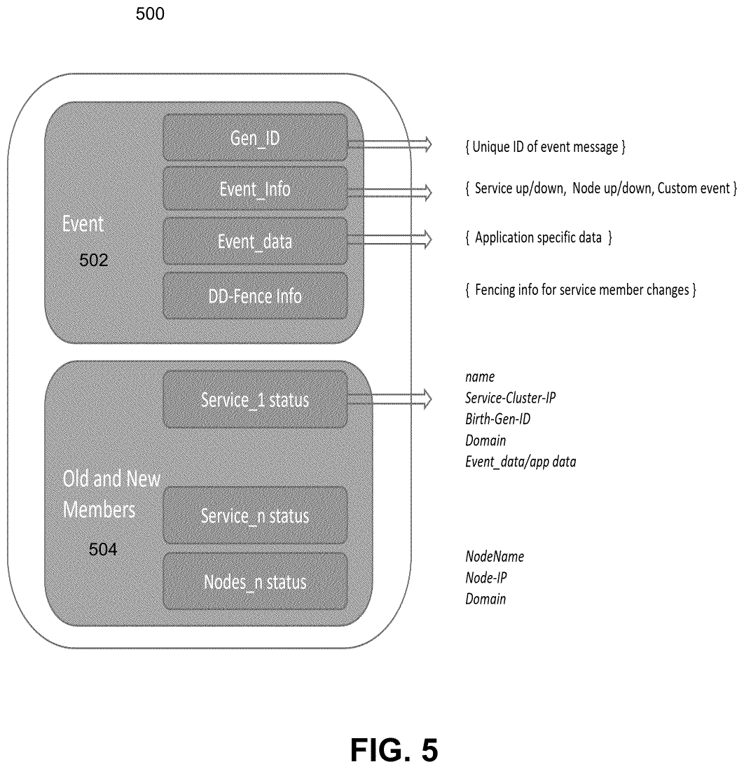

FIG. 5 illustrates an event structure 502 and membership list 504 for a CEM module, under some embodiments. The events can be either Kubernetes events or custom events. Kubernetes events involve network resources like services, pods and nodes watched by the CEM. Thus, any addition, deletion, or status change of the above resource results in service event or node events getting queued 308. Custom events are application-specific events constructed by CEM subscribers and posted to the CEM.

As shown in diagram 500 of FIG. 5, an event message 500 has a number of parts including an ID field, an event info field, event data, and Data Domain fence information, though other fields are also possible. These parts specify event information, such as event details being published, event type (i.e., service event, node event, custom event, etc.), details of the specific event (e.g., cluster-IP address if the event is service or node type), member status (e.g., member-added, member-removed, member-state-change), and application specific data provided by clients during subscribe or other workflows. The DD-Fence info node and service member list at the time of event was queued contains old and new members for nodes and services.

The old and new members are kept in a membership list 504. This list contains the status for each of the n members in the network. Members can be services, nodes, pods, and so on. Each member will has certain items of information, such as name, node cluster-IP (cluster-IP of nodes and service members retrieved from Kubernetes), Birth-Gen-ID (the ID the subscriber subscribed as assigned by the CEM server), domain (the domain in which the Service/Node exists, and Event_data, which is the last application specific data passed by the client via a subscribe or set_subs_state workflow. For node members, the membership list stores the node_name, the node IP address, and the domain.

The data items in FIG. 5 are provided for purposes of example, and other or additional items specifying the status and contents of members and events are also possible.

The CEM 304 generally guarantees that events 308 are delivered in FIFO order. It also ensures that any event delivered is also processed in a hierarchical order across all clients. To support this feature, CEM clients are configured to provide an event-callback function table where, each function defined will have an associated priority ID. This ID is used to maintain priorities, so that any event delivered with a high-priority-id callback function is called before low priority callback functions across all the services.

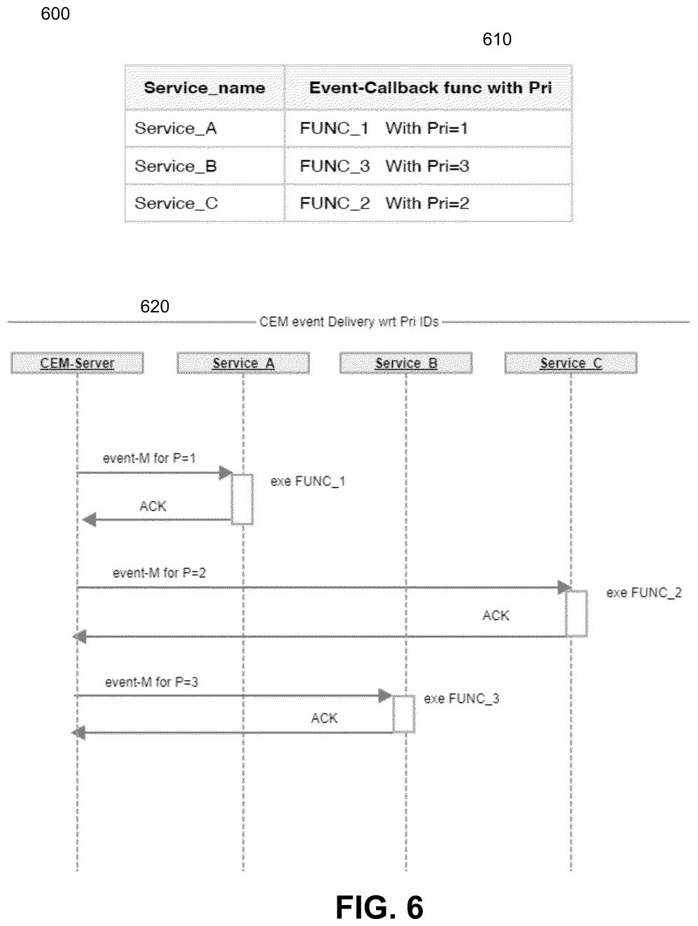

An example of this prioritization scheme is illustrated in diagram 600 of FIG. 6, which shows a table 600 listing services denoted ‘Service_A, Service_B, Service_C’, each with a corresponding event callback function with a priority level. For this example, the callback functions for services A, B, and C Priority IDs 1,3,2, respectively. Considering this order, event delivery from CEM ensures that Service_A (priority=1) processes the event before Service_C (priority=2) and, Service_C (priority=2) processes the event before Service_B (priority=3).

Flow diagram 620 of FIG. 6 illustrates the CEM event delivery workflow for the services A, B, and C of table 610, under this example embodiment.

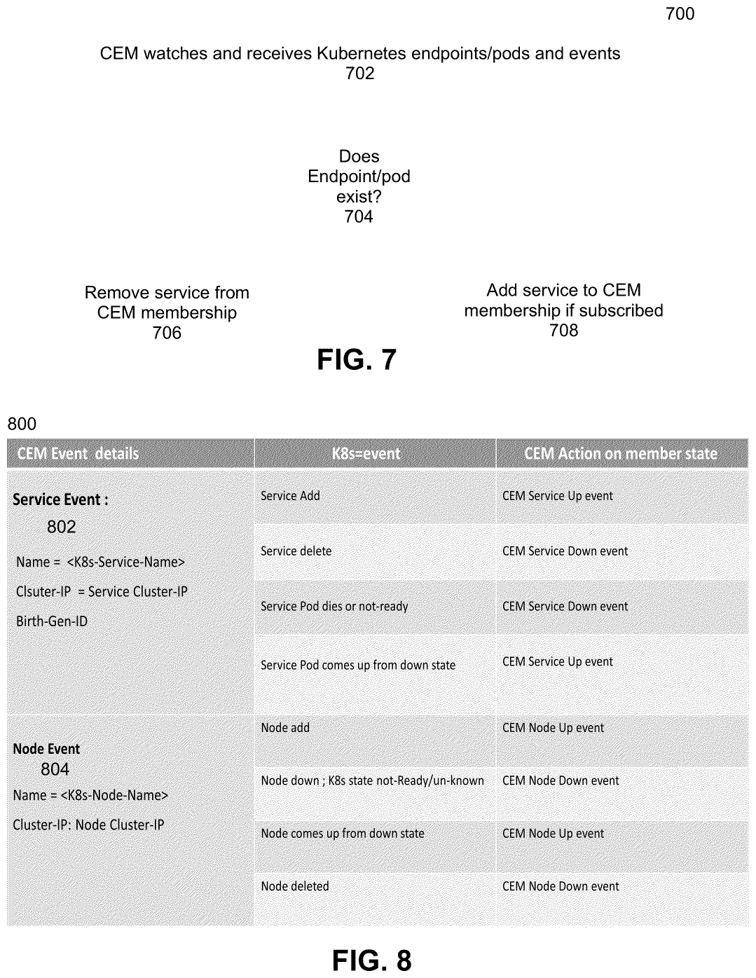

FIG. 7 is a flowchart that illustrates a method of processing events in a CEM, under some embodiments. For process 700 of FIG. 7, it is assumed that clients and pods using service IPs to communicate with other pods and deployments. The CEM watches and receives in streaming fashion Kubernetes service events and associated endpoints/pod events, and node events, 702. Service IPs are persistent or sticky IP addresses that are assigned to applications when they are running as a service in the Kubernetes environment. These IPs are assigned during deployment of the service/application and persist until the service is un-installed or deleted.

In decision block 704 it is determined whether or not an endpoint/pod exists for the service. If not, the service is removed from CEM membership, 706. If an endpoint/pod does exist and has also subscribed to the CEM, the service is added to CEM membership, 708.

For a node event, the process is similar to that of method 700, except that node members are added and deleted to the member list based on the Kubernetes events tracked by the CEM.

An event is generated if there is a change in service state (e.g., READY to NOT_READY or vice-versa), a new service is added and is in a READY state, or an existing service has been deleted. The CEM workflow thus involves a service UP event, a service DOWN event, and service DOWN and UP event, or a custom event.

FIG. 8 is a table 800 that illustrates Kubernetes events 803 and corresponding CEM action on member states for different service events 802 and node events 804. As shown in example table 800, service events 802 are specified by name, cluster IP, and Gen-ID, and comprise service adds, deletes, being down, or coming up. These events each correspond to a CEM action, such as CEM Service Up or CEM Service Down actions. Similarly, node events 804 are specified by name and cluster IP, and comprise node add, node down (not ready), node down (from up), and node deleted, which correspond to CEM Node Up or CEM Node Down actions.

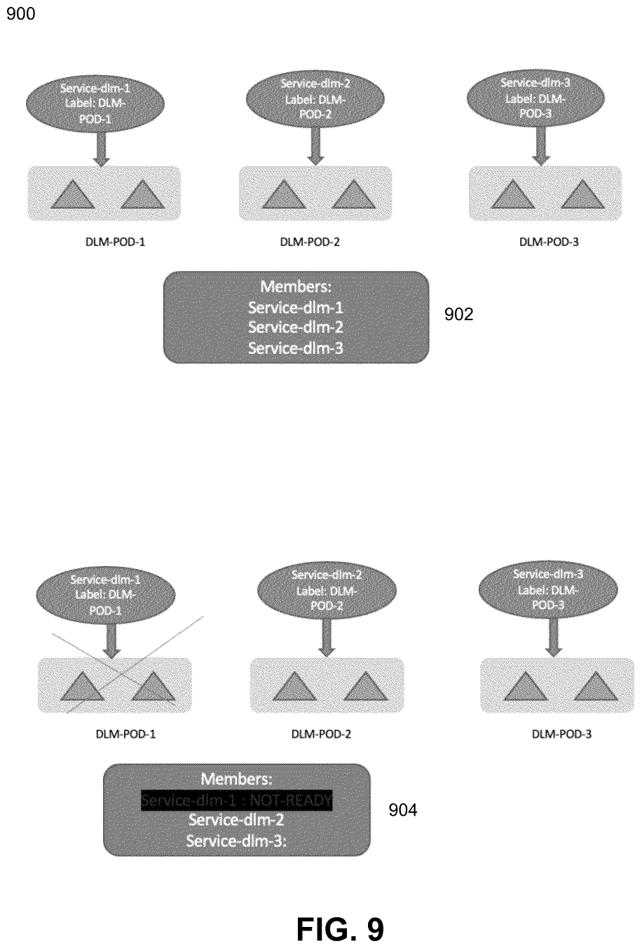

The membership list is updated according to these events. FIG. 9 illustrates an example of a membership list change based on CEM process, under an example embodiment. As shown in diagram 900 of FIG. 9, certain DLM (Distributed Lock Manager) services are performed by respective pods DLM-POD-1, DLM-POD-2, and DLM-POD-3. The membership list 902 lists the corresponding services as Service-dlm-1, Service-dlm-2, and Service-dlm-3. In the case the POD-1 dies, or some similar event occurs, its service is removed from the membership list 902 to produce membership list 904.

As mentioned, a CEM action comprises a CEM Service Up event or CEM Service Down event. A Service Up workflow first adds subscriber services (e.g., SVC-1) to a subscriber list. It then creates the Service Up event and pushes it to the queue. A Service Down workflow is triggered by Kubernetes when a service goes down, i.e. when a corresponding pod terminates or the pod transitions to a not-ready state. A service member going down will generate Kubernetes event, which the CEM will catch and queue a with a unique gen-id. This queued event is ultimately published to all subscribers in an orderly fashion. A Service Up and Down event triggers notified members to execute callbacks in a priority order.

Node related events are processed similarly for Node Up, Node Down actions. The node events are retrieved by the Kubernetes API server and then queued and persisted in the CEM. The CEM member list is updated based on the type of event. For example, if the event is a node addition, the new member is seen in the node member list in the event message.

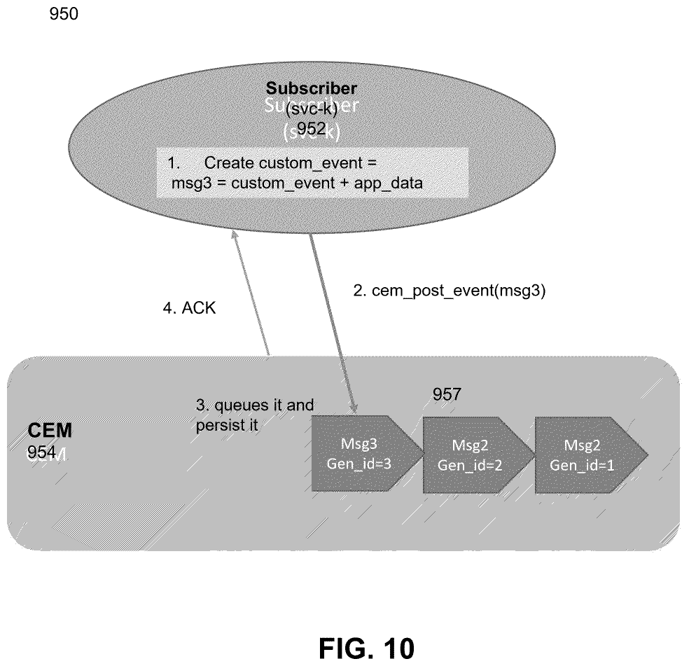

As described above, events can be Kubernetes events or custom events defined by subscribers or clients. FIG. 10 is a diagram 950 that illustrates posting custom events in a CEM system, under some embodiments. As shown in FIG. 10, a subscriber 952 posts a custom event, where a custom event is an application specific event (e.g., Log-replay done by internal application logic, or similar). The application may choose to attach some data along with this event if appropriate, and the event is opaque to the CEM. The custom event may be written in any appropriate format, such as shown: “msg3=custom_event+app data”.

The message is posted to the CEM 954, which watches an event watcher. The CEM then queues the event in queue 957, and persists the event. After this, the CEM sends an acknowledgement message ACK back to the subscriber 952. The persist post operation allows the event to be queued/persisted like every other event in CEM, and the event is published to all active subscribers.

The custom event workflow 950 of FIG. 10 allows CEM subscribers to create their own event and attach application data with the event. The posted event is queued in CEM such that it will be published to all clients. The workflow is invoked when subscribers call an appropriate command (e.g., cem_post_event( ). As shown in FIG. 10, the workflow 950 queues a custom event in the CEM queue 957 along with the event_data passed by the client. The CEM 954 processes the queue and ultimately publishes the event to all subscribers.

A subscribe workflow allows applications to register with CEM, where all CEM subscribers including the subscribing client would be notified about events. The subscribing application passes a service name, domain name, event data which corresponds to application specific data, and an event callback function table containing functions with associated priority-IDs. The workflow issues the request to the CEM server, which then generates a CEM service-UP event message with the following details: unique Gen-ID, event details (e.g., event_type or ‘service up event’ in case of subscribe), event data which corresponds to application specific data passed by the client. The CEM also calls into a DD-fence API and attaches it to the event message. The message also includes member list which includes old/new service-members and node members.

The subscription workflow then queues the event message and persists it in the persistent store (e.g., zookeeper cluster 314). A background process reads the queue and publish events in FIFO order. Each event is delivered to all clients in a such a way that it is processed in a hierarchical order across all subscribers. The subscribing application also gets its own service event and all events from that point onwards. The CEM server queues and persists the Service-UP event upon receiving the subscribe request. This event includes: a unique Gen_ID, event info, event_data (opaque to CEM), and old/new service members and node members. In the background the queue is processed by CEM, which notifies each client to execute prioritized callback functions, and once these are executed the service is registered with CEM.

An un-subscribe workflow allows applications to deregister with CEM, where all other CEM subscribers would also be notified about this event. An unsubscribe workflow queues the service event and persists it in the persistent store (zookeeper). A background process reads the queue and publishes events in FIFO order. Each event is delivered to clients in a such a way that it is processed in a hierarchical order across all subscribers. The unsubscribing application will get its own service event but will not get anymore events from that point onwards. A callback function is used to indicate that the unsubscribing application has been deregistered.

A set subscriber state workflow allows any CEM subscriber to notify other subscribers about its internal state change. FIG. 11 is a diagram illustrating a set subscriber workflow 1100, under some embodiments. As shown in FIG. 11, a particular service (SVC-A) of services 1102 invokes a command (CEM_subs_state_change) to report a change. The internal state is embedded in the event_data field of the event message. The workflow creates a service-state-change event with a unique Gen-ID, given event_data, as shown in CEM 1104. The CEM then queues and persists in zookeeper 1106, the service-state-change event along with event_data, and saves this event_data as the last received event_data from the subscriber. Ultimately the service-state-change event plus event_data will be delivered to all subscribers 1102.

For down subscribers who missed this state change event, when they come-up and subscribe, the CEM includes the member in the corresponding service-up event. Each service member info will consist of its last sent event_data with other details. Interested subscribers should be able to interpret event_data and get internal state of any service member. The event is then published to all subscribers in the background.

In an embodiment, the CEM 304 exercises an ‘exactly-once’ processing workflow. For the server, this requires that a message should be queued and persisted once. When a subscriber subscribes to cluster event notification; it gets a subscriber ID (subs_ID). For every message sent by the subscriber to CEM, the sequence ID increases monotonically. The CEM accepts and processes the message only if the sequence number of the message is exactly one greater than the last message sent from that subscriber. Likewise, for the client, this requires that the CEM client library will ensure that duplicate event is not delivered to the client callbacks, and the client checks the event Gen-ID of an in-process or already processed event.

In certain cases, errors in the system may be encountered. These may be caused by a variety of different reasons, such as a client pod dying and restarting, a client hanging or not responding, a client restarting within a heartbeat interval, or the server restarting, among other similar occurrences. In an embodiment, the CEM 304 includes certain error handling mechanisms. Generally, an error is caught by the CEM and queued/persisted as a service-down event indicating. The subscribers will be notified to exclude any down or unavailable service. If the service later comes up, the down service can be subscribes again, and the CEM creates a corresponding service-up event, queues it and later publishes it.

When a CEM client hangs or is slow in responding, if the CEM is in the middle of publishing an event and waiting for an ACK from the non-responsive member, it will wait until it gets either an ACK from the member (i.e., the member recovers itself and starts responding), or a service down event from Kubernetes for the corresponding service.

A CEM client restarting within a heartbeat interval is an example of a situation where a container/process inside the member pod restarts without generating a Kubernetes event. In such this case, the service was already a member while it re-subscribed (i.e., the old member list and new member list looks the same). The CEM still creates a service-up event with unique gen-id but same old/new members, and the service-up event is published to all subscribers, but the re-subscribing member will get a new Birth-Gen-ID.

For a CEM server restart conditions, there can be situations that while there are multiple service members already subscribed to the CEM, it restarts. In this case, the CEM client library will see connection errors and therefore figure out that CEM service is down. In the background re-connect will be issued which is not same as subscribed. The CEM restart should build its queue from the HA persistent store in order to start from where it left off, and grab and queue missed events from Kubernetes, and start watching for new events. It should also wait for previously subscribed members to re-connect. The CEM can mark itself ready once members have re-connected, that is, it is ready to publish and receive events.

As described, the CEM system tracks various events in a large-scale distributed network in terms of membership changes, services going down, new services getting added or existing services getting deleted, new nodes getting added/deleted, and so on. It then notifies all subscribing members of these events in the order of occurrence via event notification so that subscribers can take appropriate action on their end.

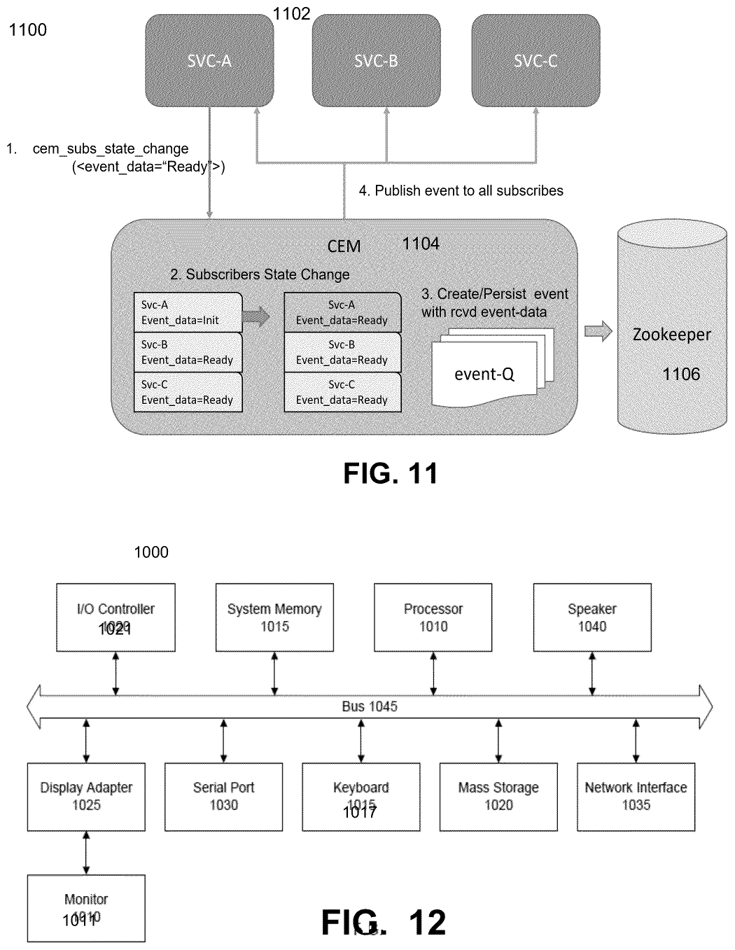

FIG. 12 is a block diagram of a computer system used to execute one or more software components of a service scaling process for distributed systems, under some embodiments. The computer system 1000 includes a monitor 1011, keyboard 1017, and mass storage devices 1020. Computer system 1000 further includes subsystems such as central processor 1010, system memory 1015, input/output (I/O) controller 1021, display adapter 1025, serial or universal serial bus (USB) port 1030, network interface 1035, and speaker 1040. The system may also be used with computer systems with additional or fewer subsystems. For example, a computer system could include more than one processor 1010 (i.e., a multiprocessor system) or a system may include a cache memory.

Arrows such as 1045 represent the system bus architecture of computer system 1000. However, these arrows are illustrative of any interconnection scheme serving to link the subsystems. For example, speaker 1040 could be connected to the other subsystems through a port or have an internal direct connection to central processor 1010. The processor may include multiple processors or a multicore processor, which may permit parallel processing of information. Computer system 1000 is an example of a computer system suitable for use with the present system. Other configurations of subsystems suitable for use with the present invention will be readily apparent to one of ordinary skill in the art.

Computer software products may be written in any of various suitable programming languages. The computer software product may be an independent application with data input and data display modules. Alternatively, the computer software products may be classes that may be instantiated as distributed objects. The computer software products may also be component software. An operating system for the system may be one of the Microsoft Windows®, family of systems (e.g., Windows Server), Linux, Mac™ OS X, IRIX32, or IRIX64. Other operating systems may be used.

Although certain embodiments have been described and illustrated with respect to certain example network topographies and node names and configurations, it should be understood that embodiments are not so limited, and any practical network topography is possible, and node names and configurations may be used.

Embodiments may be applied to data, storage, industrial networks, and the like, in any scale of physical, virtual or hybrid physical/virtual network, such as a very large-scale wide area network (WAN), metropolitan area network (MAN), or cloud-based network system, however, those skilled in the art will appreciate that embodiments are not limited thereto, and may include smaller-scale networks, such as LANs (local area networks). Thus, aspects of the one or more embodiments described herein may be implemented on one or more computers executing software instructions, and the computers may be networked in a client-server arrangement or similar distributed computer network. The network may comprise any number of server and client computers and storage devices, along with virtual data centers (vCenters) including multiple virtual machines. The network provides connectivity to the various systems, components, and resources, and may be implemented using protocols such as Transmission Control Protocol (TCP) and/or Internet Protocol (IP), well known in the relevant arts. In a distributed network environment, the network may represent a cloud-based network environment in which applications, servers and data are maintained and provided through a centralized cloud-computing platform.

Some embodiments of the invention involve data processing, database management, and/or automated backup/recovery techniques using one or more applications in a distributed system, such as a very large-scale wide area network (WAN), metropolitan area network (MAN), or cloud based network system, however, those skilled in the art will appreciate that embodiments are not limited thereto, and may include smaller-scale networks, such as LANS (local area networks). Thus, aspects of the one or more embodiments described herein may be implemented on one or more computers executing software instructions, and the computers may be networked in a client-server arrangement or similar distributed computer network.

Although embodiments are described and illustrated with respect to certain example implementations, platforms, and applications, it should be noted that embodiments are not so limited, and any appropriate network supporting or executing any application may utilize aspects of the backup management process described herein. Furthermore, network environment 100 may be of any practical scale depending on the number of devices, components, interfaces, etc. as represented by the server/clients and other elements of the network. For example, network environment 100 may include various different resources such as WAN/LAN networks and cloud networks 102 are coupled to other resources through a central network 110.

For the sake of clarity, the processes and methods herein have been illustrated with a specific flow, but it should be understood that other sequences may be possible and that some may be performed in parallel, without departing from the spirit of the invention. Additionally, steps may be subdivided or combined. As disclosed herein, software written in accordance with the present invention may be stored in some form of computer-readable medium, such as memory or CD-ROM, or transmitted over a network, and executed by a processor. More than one computer may be used, such as by using multiple computers in a parallel or load-sharing arrangement or distributing tasks across multiple computers such that, as a whole, they perform the functions of the components identified herein; i.e., they take the place of a single computer. Various functions described above may be performed by a single process or groups of processes, on a single computer or distributed over several computers. Processes may invoke other processes to handle certain tasks. A single storage device may be used, or several may be used to take the place of a single storage device.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

All references cited herein are intended to be incorporated by reference. While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of providing event notification in a distributed network, comprising:
deploying a cluster event notification module (CEM) running on a container orchestration service of the distributed network;
creating a membership map of subscribers using resources and services of the network;
receiving, in the CEM, events affecting membership and availability of resources in the network for the subscribers;
queueing the received events in a queue, wherein a list of subscribers at the time of the event is embedded in event data for each event; and
notifying all subscribers of the received events in an order as received and queued through a publication process to allow one or more subscribers to reconfigure their own services or resources to ensure that no event is missed and maintain reliability of event notification.

2. The method of claim 1 further comprising receiving, in the CEM, a callback from each subscriber of the subscribers as acknowledgment of publication.

3. The method of claim 1 wherein the distributed network comprises a containerized network running a containerized data filesystem, and wherein the resources comprise services, nodes, and pods of the network.

4. The method of claim 3 wherein the events comprise at least one of: a service deletion or addition, a node crash or addition, or a pod crash or addition.

5. The method of claim 4 wherein the events further comprise custom events defined by a subscriber of the subscribers.

6. The method of claim 3 further comprising persisting the queue and a queue state of queued events in a zookeeper cluster of the network.

7. The method of claim 3 further comprising:
establishing a priority among the subscribers; and
maintaining the priority as a hierarchical order for receipt of the queued events from the CEM.

8. The method of claim 3 wherein each event of the events is processed by the CEM and subscribers no more than once after receipt of the event by the CEM.

9. The method of claim 8 wherein the publication process is decoupled from a process executing the event.

10. A method of providing event notification in a distributed network, comprising:
deploying an ordered event queue on top of a container orchestration service (COS) in a server of the distributed network, wherein the network comprises a plurality of subscriber services;
collecting membership change events in the COS, wherein a list of the subscribers at the time of event is embedded in data of the event;
publishing the events in the network for delivery to all subscribers in a same order of collection and in a priority order established for the subscribers to ensure that no event is missed and maintain reliability of event notification;
processing each queued event, by the COS and the subscribers, no more than once and in a process decoupled from the publishing; and
executing, upon receipt of an event by each subscriber, a local callback function that is pre-determined for the event.

11. The method of claim 10 wherein the distributed network comprises a containerized network running a containerized data filesystem, and wherein the resources comprise services, nodes, and pods of the network.

12. The method of claim 11 wherein the system events and custom events, and wherein the system events comprise at least one of: a service deletion or addition, a node crash or addition, or a pod crash or addition, and further wherein the custom events are defined by a subscriber of the subscribers.

13. The method of claim 12 further comprising persisting the queue and a queue state of queued events in a zookeeper cluster of the network.

14. The method of claim 10 further comprising any component in the distributed system to generate an event for publication by the OCS, and further configuring any component to be a subscriber.

15. The method of claim 14 wherein an event generates an event message comprising a number of data elements specifying a unique event message identifier, an event type, application and specific data.

16. The method of claim 15 further comprising maintaining a list of the subscribers in a membership list, the membership list comprising a status data structure for each subscriber and including subscriber name, network address, generation time identifier, domain, and application data of the subscriber.

17. A system for providing event notification in a distributed network, comprising:
a cluster event notification module (CEM) running on a container orchestration service of the distributed network;
a database component storing a membership map of subscribers using resources and services of the network;
an interface of the CEM receiving events affecting membership and availability of resources in the network for the subscribers, wherein a list of subscribers at the time of the event is embedded in event data for each event;
a processor-based queue holding the received events in a defined; and
a publication component notifying all subscribers of the received events in an order as received and queued to allow one or more subscribers to reconfigure their own services or resources, the interface in the CEM further receiving a callback from each subscriber of the subscribers as acknowledgment of publication.

18. The system of claim 17 wherein the distributed network comprises a containerized network running a containerized data filesystem, and wherein the resources comprise services, nodes, and pods of the network.

19. The system of claim 18 wherein the events comprise at least one of: a service deletion or addition, a node crash or addition, or a pod crash or addition, and further wherein the events further comprise custom events defined by a subscriber of the subscribers.

20. The method of claim 19 wherein each event of the events is processed by the CEM and subscribers no more than once after receipt of the event by the CEM.
